(19) United States
(12) Patent Application Publication
(10) Pub. No.: US 2014/0343205 A1
(43) Pub. Date: Nov. 20, 2014

(54) POLYPROPYLENE COMPOSITION WITH IMPROVED ADDITIVE RETENTION

(71) Applicant: TOTAL RESEARCH & TECHNOLOGY FELUY, Seneffe (BE)

(72) Inventor: Geoffroy Terlinden, Wezembeek-Oppem (BE)

(21) Appl. No.: 14/345,298

(22) PCT Filed: Sep. 18, 2012
(86) PCT No.: PCT/EP2012/068347

§ 371 Date: Mar. 17, 2014

(30) Foreign Application Priority Data
Sep. 19, 2011 (EP) 11181790.4

(51) Int. Cl. C08K 5/103; B29C 47/00; B29C 45/00; B29C 49/06; B29C 49/04

(52) U.S. Cl. CPC C08K 5/103; B29C 49/06; B29C 49/04; B29C 45/0001; B29C 47/0054; B29C 47/0021; C08K 2201/017; B29K 2023/14
USPC 524/317; 264/531; 264/537; 264/540; 264/328.1

(57) ABSTRACT

A polypropylene composition characterized by improved additive retention can include at least 70 wt. % of a component (A) that is a random copolymer of propylene and ethylene produced with a metallocene-based polymerization catalyst. The component (A) can have a molecular weight distribution of at most 4.0. The polypropylene composition can include from 0.001 to 2.0 wt. % of a component (B) that is an additive that migrates to a surface of the polypropylene composition. The polypropylene composition can include a component (C) that is a thermoplastic polymer different from component (A), and is not a metallocene polypropylene homopolymer. The polypropylene composition can have a gloss at 20° of at least 75. Articles can be produced from the polypropylene composition, including articles that require specific surface properties over an extended period of time.

### FIELD OF THE INVENTION

The present invention relates to polypropylene compositions, which are characterized by improved additive retention, as well as to articles comprising such polypropylene compositions. The present invention is particularly useful for articles requiring specific surface properties over an extended period of time.

### THE TECHNICAL PROBLEM AND THE PRIOR ART

The vast majority of commercial polypropylene is either homopolymer of propylene or copolymer of propylene with other olefins, generally with other alpha-olefins. The nature of the monomers leads to polymers essentially consisting of carbon and hydrogen only, thus also resulting in specific properties of the polymers, such as for example a hydrophobic surface or chemical inertness to a wide range of chemicals.

Depending upon the final use of the polypropylene, its inherent properties may be more or less desired. In consequence, polymer producers and converters try to change the properties by the addition of additives into the polypropylene. Some of these additives, particularly the ones which are intended to modify the surface properties, are migrating additives, which after having been added into the polypropylene over time migrate to the surface.

A particular example of such additives are antistatic agents. Antistatic agents generally comprise a hydrophobic (non-polar) part and a hydrophilic (polar) part. After their incorporation into the polypropylene, antistatic agents need to migrate to the surface of the polypropylene in order to become effective, i.e. to render the hydrophobic surface of the polypropylene more hydrophilic and in consequence for example less susceptible to dust accumulation on the surface. This is of particular interest for durable goods, such as transport boxes and crates or garden furniture or toys to name only a few.

For durable goods to keep their appearance over an extended period of time it is normally necessary to incorporate high levels of antistatic agents. By doing so the time before the “reservoir” of antistatic agent in the polypropylene is depleted is increased.

However, high levels of antistatic agent in the polypropylene frequently lead to blooming, i.e. too much antistatic agent gathers on the polypropylene's surface and results in a matte (“non-glossy”) appearance.

The present invention is therefore concerned with providing a polypropylene composition that does not have these disadvantages.

Hence, it is an object of the present invention to provide a polypropylene composition having good gloss despite the presence of migrating additives in said polypropylene composition.

Further, it is an object of the present invention to provide a polypropylene composition wherein the level of additive can be reduced while still giving the same effect or wherein the same level leads to an increased life time of the article comprising said polypropylene composition.

Additionally, it is an object of the present invention to provide an article having these characteristics.

### BRIEF DESCRIPTION OF THE INVENTION

Any of these objectives can be attained either individually or in any combination by the following polypropylene composition wherein the polypropylene has been produced with a metallocene-based polymerization catalyst.

In consequence, the present application discloses a polypropylene composition comprising
(i) x wt % of component (A), said component (A) being a polypropylene produced with a metallocene-based polymerization catalyst, wherein x is at least 50;
(ii) y wt % of component (B), said component (B) being an additive that migrates to the surface of said polypropylene composition, wherein y is at least 0.001 and at most 2.0; and
(iii) (100−x−y) wt % of component (C), said component (C) being one or more thermoplastic polymers different from component (A),
   with the provision that x+y≦100, and with wt % relative to the total weight of said polypropylene composition,

wherein said polypropylene composition has a gloss at 20° of at least 75, determined on 1 mm thick plaques having been produced by injection molding and stored at 40° C.±1° C. for three days before measuring gloss at 20° in accordance with ASTM D 2457.

The present application also discloses articles consisting of said polypropylene composition and a process for the production of an article having improved additive retention, said process comprising the steps of
(a) providing a polypropylene composition as defined above; and
(b) transforming said polypropylene composition into an article by a process selected from the group consisting of injection molding, extrusion blow molding, extrusion-thermoforming, sheet extrusion, film extrusion, pipe extrusion, and injection stretch-blow molding.

Additionally, the present application discloses the use of a polypropylene composition according to claim 1 to reduce the migration rate of said component (B), characterized in that the difference in gloss of the 1 mm thick injection molded plaques measured three days following injection molding and 25 days following injection is at most 70% of the difference in gloss of the 1 mm thick injection molded plaques stored at 40° C.±1° C. measured three days following injection molding and 25 days following injection molding for the same polypropylene composition wherein for component (A) the polypropylene produced with a polymerization catalyst comprising a metallocene was substituted with a polypropylene produced with a Ziegler-Natta polymerization catalyst.

### BRIEF DESCRIPTION OF THE DRAWING

FIG. 1 shows the evolution of gloss at 20° with time obtained for compositions comprising a metallocene polypropylene as well as for comparative compositions comprising a Ziegler-Natta polypropylene.

FIG. 2 shows the migration, in the mold, of the additive in a metallocene polypropylene as well as for comparative composition comprising a Ziegler-Natta polypropylene.

### DETAILED DESCRIPTION OF THE INVENTION

Throughout the present application the terms “polypropylene” and “propylene polymer” may be used synonymously.

Throughout the present application, melt flow index, abbreviated as “MFI”, of polypropylene and polypropylene compositions is determined according to ISO 1133, condition L, at 230° C. and 2.16 kg.

In general terms the present application provides for a polypropylene composition comprising a component (A), a component (B) and a component (C) as defined below.

Polypropylene Composition

The present polypropylene composition comprises
(i) x wt % of a component (A), wherein x is at least 50;
(ii) y wt % of a component (B), wherein y is at least 0.001 and at most 2.0; and
(iii) (100−x−y) wt % of a component (C).
   with the provision that x+y≦100, and with wt % relative to the total weight of said polypropylene composition.

Preferably, for the present polypropylene composition x is at least 70, or 80 or 90, more preferably at least 95 or 97 or 98, even more preferably at least 98.5 or 98.6 or 98.7 or 98.8 or 98.9, and most preferably at least 99.0.

Preferably, for the present polypropylene composition y is at least 0.005, more preferably at least 0.01 or 0.02 or 0.03, even more preferably at least 0.04 or 0.06, still even more preferably at least 0.08 and most preferably at least 0.10.

Preferably, for the present polypropylene composition y is at most 1.5, more preferably at most 1.4 or 1.3, even more preferably at most 1.2 or 1.1, and most preferably at most 1.0.

Component (C) is comprised in the present polypropylene composition in such an amount that the combined weight percentages of components (A), (B) and (C) add up to 100 wt %

The present polypropylene composition is characterized by a gloss at 20° of at least 75. Said gloss is preferably at least 80, more preferably at least 85, and most preferably at least 90. Gloss is determined as indicated in the test methods.

The melt flow index of the present polypropylene composition is not particularly limited. It is, nevertheless, preferred that the melt flow index is at least 0.1 dg/min or 1.0 dg/min, more preferably at least 5 dg/min, and most preferably at least 10 dg/min. It is preferred that the melt flow index is at most 500 dg/min, more preferably at most 400 dg/min or 300 dg/min or 200 dg/min, even more preferably at most 150 dg/min, and most preferably at most 100 dg/min.

Component (A)

Component (A) is a polypropylene produced with a metallocene-based polymerization catalyst (“metallocene polypropylene”). It is preferred that the polypropylene is a random copolymer of propylene and at least one comonomer, said comonomer being an alpha-olefin different from propylene.

With regards to the at least one comonomer, it is preferred that it is an alpha-olefin having from one to ten carbon atoms. More preferably, the alpha-olefin is selected from the group consisting of ethylene, butene-1, pentene-1, hexene-1, heptene-1, hexene-1 and 4-methyl-pentene-1. Even more preferably, the alpha-olefin is selected from the group consisting of ethylene, butene-1 and hexene-1. Most preferably, the alpha-olefin is ethylene. Hence, the most preferred random copolymer is a random copolymer of propylene and ethylene (C3-C2).

Said random copolymer comprises at least 0 wt %, preferably at least 0.5 wt %, more preferably at least 1.0 wt % or 1.1 wt %, even more preferably at least 1.2 wt % or 1.3 wt %, still even more preferably at least 1.4 wt %, and most preferably at least 1.5 wt % of the at least one comonomer, relative to the total weight of said random copolymer. In case the comonomer content is 0 wt %, the random copolymer may also be referred to as a propylene homopolymer.

Said random copolymer comprises at most 6.0 wt %, more preferably at most 5.0 wt %, even more preferably at most 4.5 wt %, and most preferably at most 4.0 wt % of the at least one comonomer, relative to the total weight of said random copolymer.

Preferably, the metallocene polypropylene used herein has a high degree of isotacticity, for which the content of mmmm pentads is a measure. Thus, preferably the content of mmmm pentads is at least 90%, more preferably at least 92%, even more preferably at least 94% and most preferably at least 96%. The content of mmmm pentads may be determined by ¹³C-NMR analysis as described in the test methods.

Further, the metallocene polypropylene used herein preferably has a content of 2,1-insertions of at most 1.5%, more preferably of at most 1.3%, even more preferably of at most 1.2%, still even more preferably of at most 1.1% and most preferably of at most 1.0%. Preferably the content of 2,1-insertions is at least 0.1%. The percentage of 2,1-insertions is given relative to the total number of propylene monomers in the polymeric chain and may be determined by ¹³C-NMR analysis as given in more detail in the test methods.

Preferably, the metallocene polypropylene used herein has a molecular weight distribution, defined as M_{w}/Mₙ, i.e. the ratio of weight average molecular weight M_{w} over number average molecular weight Mₙ, of at most 4.0. Preferably, the metallocene polypropylene used herein has a molecular weight distribution, defined as M_{w}/Mₙ, of at most 3.5, more preferably of at most 3.0, and most preferably of at most 2.8. Preferably, the metallocene polypropylene used herein has a molecular weight distribution (MWD), defined as M_{w}/Mₙ, of at least 1.0, more preferably of at least 1.5 and most preferably of at least 2.0. Molecular weights can be determined by size exclusion chromatography (SEC), frequently also referred to as gel permeation chromatography (GPC), as described in the test methods.

The metallocene polypropylene used herein is obtained by polymerizing propylene and at least one comonomer with a metallocene-based polymerization catalyst. Preferably the metallocene-based polymerization catalyst comprises a bridged metallocene component, a support and an activating agent. Such metallocene-based polymerization catalysts are generally known in the art and need not be explained in detail.

The metallocene component can be described by the following general formula

(μ-R^{a})(R^{b})(R^{c})MX¹X² (I)

wherein R^{a}, R^{b}, R^{c}, M, X¹ and X² are as defined below.

R^{a} is the bridge between R^{b} and R^{c}, i.e. R^{a} is chemically connected to R^{b} and R^{c}, and is selected from the group consisting of —(CR¹R²)ₚ—, —(SiR¹R²)ₚ—, —(GeR¹R²)ₚ—, —(NR¹)ₚ—, —(PR¹)ₚ—, —(N⁺R¹R²)ₚ— and —(P⁺R¹R²)ₚ—, and p is 1 or 2, and wherein R¹ and R² are each independently selected from the group consisting of hydrogen, C₁-C₁₀ alkyl, C₅-C₈ cycloalkyl, C₆-C₁₅ aryl, alkylaryl with C₁-C₁₀ alkyl and C₆-C₁₅ aryl, or any two neighboring R (i.e. two neighboring R¹, two neighboring R², or R¹ with a neighboring R²) may form a cyclic saturated or non-saturated C₄-C₁₀ ring; each R¹ and R² may in turn be substituted in the same way. Preferably R^{a} is —(CR¹R²)ₚ— or —(SiR¹R²)ₚ— with R¹, R² and p as defined above. Most preferably R^{a} is —(SiR¹R²)ₚ— with R¹, R² and p as defined above. Specific examples of R^{a} include Me₂C, ethanediyl (—CH₂—CH₂—), Ph₂C and Me₂Si.

M is a metal selected from Ti, Zr and Hf, preferably it is Zr.

X¹ and X² are independently selected from the group consisting of halogen, hydrogen, C₁-C₁₀ alkyl, C₆-C₁₅ aryl, alkylaryl with C₁-C₁₀ alkyl and C₆-C₁₅ aryl. Preferably X¹ and X² are halogen or methyl.

R^{b} and R^{c} are selected independently from one another and comprise a cyclopentadienyl ring.

Preferred examples of halogen are Cl, Br, and I. Preferred examples of C₁-C₁₀ alkyl are methyl, ethyl, n-propyl, iso-propyl, n-butyl, iso-butyl, and tert-butyl. Preferred examples of C₅-C₇ cycloalkyl are cyclopentyl, cyclohexyl, cycloheptyl and cyclooctyl. Preferred examples of C₆-C₁₅ aryl are phenyl and indenyl. Preferred examples of alkylaryl with C₁-C₁₀ alkyl and C₆-C₁₅ aryl are benzyl (—CH₂—Ph), and —(CH₂)₂—Ph.

Preferably, R^{b} and R^{c} may both be substituted cyclopentadienyl, or may be independently from one another unsubstituted or substituted indenyl or tetrahydroindenyl, or R^{b} may be a substituted cyclopentadienyl and R^{c} a substituted or unsubstituted fluorenyl. More preferably, R^{b} and R^{c} may both be the same and may be selected from the group consisting of substituted cyclopentadienyl, unsubstituted indenyl, substituted indenyl, unsubstituted tetrahydroindenyl and substituted tetrahydroindenyl. By “unsubstituted” is meant that all positions on R^{b} resp. R^{c}, except for the one to which the bridge is attached, are occupied by hydrogen. By “substituted” is meant that, in addition to the position at which the bridge is attached, at least one other position on R^{b} resp. R^{c} is occupied by a substituent other than hydrogen, wherein each of the substituents may independently be selected from the group consisting of C₁-C₁₀ alkyl, C₅-C₇ cycloalkyl, C₆-C₁₅ aryl, and alkylaryl with C₁-C₁₀ alkyl and C₆-C₁₅ aryl, or any two neighboring substituents may form a cyclic saturated or non-saturated C₄-C₁₀ ring.

A substituted cyclopentadienyl may for example be represented by the general formula C₅R³R⁴R⁵R⁶. A substituted indenyl may for example be represented by the general formula C₉R⁷R⁸R⁹R¹⁰R¹¹R¹²R¹³R¹⁴. A substituted tetrahydroindenyl may for example be represented by the general formula C₉H₄R¹⁵R¹⁶R¹⁷R¹⁸. A substituted fluorenyl may for example be represented by the general formula C₁₃R¹⁹R²⁰R²¹R²²R²³R²⁴R²⁵R²⁶. Each of the substituents R³ to R²⁶ may independently be selected from the group consisting of hydrogen, C₁-C₁₀ alkyl, C₅-C₇ cycloalkyl, C₆-C₁₅ aryl, and alkylaryl with C₁-C₁₀ alkyl and C₆-C₁₅ aryl, or any two neighboring R may form a cyclic saturated or non-saturated C₄-C₁₀ ring; provided, however, that not all substituents simultaneously are hydrogen.

Preferred metallocene components are those having C₂-symmetry or those having C₁-symmetry. Most preferred are those having C₂-symmetry.

Particularly suitable metallocene components are those wherein R^{b} and R^{c} are the same and are substituted cyclopentadienyl, preferably wherein the cyclopentadienyl is substituted in the 2-position, the 3-position, or simultaneously the 2-position and the 3-position.

Particularly suitable metallocene components are also those wherein R^{b} and R^{c} are the same and are selected from the group consisting of unsubstituted indenyl, unsubstituted tetrahydroindenyl, substituted indenyl and substituted tetrahydroindenyl. Substituted indenyl is preferably substituted in the 2-position, the 3-position, the 4-position, the 5-position or any combination of these, more preferably in the 2-position, the 4-position or simultaneously in the 2-position and the 4-position. Substituted tetrahydroindenyl is preferably substituted in the 2-position, the 3-position, or simultaneously the 2-position and the 3-position.

Particularly suitable metallocene components may also be those wherein R^{b} is a substituted cyclopentadienyl and R^{c} is a substituted or unsubstituted fluorenyl. The substituted cyclopentadienyl is preferably substituted in the 2-position, the 3-position, the 5-position or simultaneously any combination of these, more preferably in the 3-position or the 5-position or both simultaneously, most preferably in the 3-position only, with a bulky substituent. Said bulky substituent may for example be —CR²⁷R²⁸R²⁹ or —SiR²⁷R²⁸R²⁹ with R²⁷, R²⁸ and R²⁹ independently selected from group consisting of C₁-C₁₀ alkyl, C₅-C₇ cycloalkyl, C₆-C₁₅ aryl, and alkylaryl with C₁-C₁₀ alkyl and C₆-C₁₅ aryl, or any two neighboring R may form a cyclic saturated or non-saturated C₄-C₁₀ ring. It is preferred that R²⁷, R²⁸ and R²⁹ are methyl.

Examples of particularly suitable metallocenes are: dimethylsilanediyl-bis(2-methyl-cyclopentadienyl)zirconium dichloride, dimethylsilanediyl-bis(3-methyl-cyclopentadienyl)zirconium dichloride, dimethylsilanediyl-bis(3-tert-butyl-cyclopentadienyl)zirconium dichloride, dimethylsilanediyl-bis(3-tert-butyl-5-methyl-cyclopentadienyl)zirconium dichloride, dimethylsilanediyl-bis(2,4-dimethyl-cyclopentadienyl)zirconium dichloride, dimethylsilanediyl-bis(indenyl)zirconium dichloride, dimethylsilanediyl-bis(2-methyl-indenyl)zirconium dichloride, dimethylsilanediyl-bis(3-methyl-indenyl)zirconium dichloride, dimethylsilanediyl-bis(3-tert-butyl-indenyl)zirconium dichloride, dimethylsilanediyl-bis(4,7-dimethyl-indenyl)zirconium dichloride, dimethylsilanediyl-bis(tetrahydroindenyl)zirconium dichloride, dimethylsilanediyl-bis(benzindenyl)zirconium dichloride, dimethylsilanediyl-bis(3,3′-2-methyl-benzindenyl)zirconium dichloride, dimethylsilanediyl-bis(4-phenyl-indenyl)zirconium dichloride, dimethylsilanediyl-bis(2-methyl-4-phenyl-indenyl)zirconium dichloride, ethanediyl-bis(indenyl)zirconium dichloride, ethanediyl-bis(tetrahydroindenyl)zirconium dichloride, isopropylidene-(3-tert-butyl-cyclopentadienyl)(fluorenyl)zirconium dichloride isopropylidene-(3-tert-butyl-5-methyl-cyclopentadienyl)(fluorenyl)zirconium dichloride.

The metallocene may be supported according to any method known in the art. In the event it is supported, the support used in the present invention can be any organic or inorganic solid, particularly porous supports such as talc, inorganic oxides, and resinous support material such as polyolefin. Preferably, the support material is an inorganic oxide in its finely divided form.

The metallocene polypropylene used herein is produced by polymerizing propylene and at least one comonomer in presence of a metallocene-based polymerization catalyst to obtain the metallocene polypropylene. Preferably, the metallocene polypropylene used herein is a metallocene polypropylene homopolymer produced by polymerizing propylene in presence of a metallocene-based polymerization catalyst. The polymerization in presence of a metallocene-based polymerization catalyst can be carried out according to known techniques in one or more polymerization reactors at temperatures in the range from 20° C. to 150° C. The metallocene polypropylene used herein is preferably produced by polymerization in liquid propylene at temperatures in the range from 20° C. to 120° C. More preferred temperatures are in the range from 60° C. to 100° C. The pressure can be atmospheric or higher. It is preferably between 25 and 50 bar. The molecular weight of the polymer chains, and in consequence the melt flow of the resulting metallocene polypropylene, may be controlled by the addition of hydrogen to the polymerization medium.

Preferably, the metallocene polypropylene is recovered from the one or more polymerization reactors without post-reactor treatment, such as thermal or chemical degradation (e.g. by using peroxides), to reduce its molecular weight and/or narrow the molecular weight distribution, as is often done for polypropylene produced with a Ziegler-Natta catalyst. An example for chemical degradation is visbreaking, wherein the polypropylene is reacted for example with an organic peroxide at elevated temperatures, for example in an extruder or pelletizing equipment.

The metallocene polypropylene may also comprise one or more antioxidants, one or more acid scavengers, one or more light stabilizers, one or more nucleating agents and any blend of these. The additives comprised in said metallocene polypropylene are non-migrating additives. A general overview of such additives is given in Plastics Additives Handbook, ed. H. Zweifel, 5^{th} edition, 2001, Hanser Publishers.

Component (B)

Component (B) is an additive that migrates, or in other words, has the tendency to migrate, to the surface of the present polypropylene composition, or rather to the surface of an article consisting of said polypropylene composition. For a general overview of additives it is referred to the already mentioned Plastics Additives Handbook, ed. H. Zweifel, 5^{th} edition, 2001, Hanser Publishers.

Preferably, component (B) is selected from the group consisting of antioxidants, acid scavengers, light stabilizers, lubricants, nucleating agents, antistatic agents and any blend of these. Most preferably, component (B) is an antistatic agent of a blend of more than one antistatic agents.

Suitable antistatic agents for use in the present polypropylene composition can be selected from any of the antistatic agents known to the skilled person. It is, however, preferred that the antistatic agent be selected from the group consisting of fatty acid esters, ethoxylated alkylamines, diethanolamides, ethoxylated alcohols, and blends thereof.

Examples of fatty acid esters are esters of fatty acids with general formula CₘH₂ₘ₊₁COOH, wherein CₘH₂ₘ₊₁ is a, preferably linear, hydrocarbyl group (alkyl group) with m ranging from 1 to 35, preferably from 5 to 30, even more preferably from 10 to 25, and most preferably from 15 to 20. The most preferred fatty acid esters are glycerol monostearate, glycerol distearate and glycerol tristearate.

Examples of ethoxylated amines are those of general formula CₘH₂ₘ₊₁N(CH₂—CH₂—OH)₂, wherein CₘH₂ₘ₊₁ is an alkyl group with m ranging from 1 to 30.

Examples of diethanolamides are those of general formula CₘH₂ₘ₊₁C(O)—N(CH₂—CH₂—OH)₂, wherein CₘH₂ₘ₊₁ is an alkyl group with m ranging from 1 to 30, preferably from 5 to 25 and most preferably from 10 to 20.

Examples of ethoxylated alcohols are those of general formula H—(O—CH₂—CH₂)ₙ—CₘH₂ₘ₊₁, wherein CₘH₂ₘ₊₁ is an alkyl group with m ranging from 1 to 30, preferably from 5 to 25 and most preferably from 10 to 20, and n is preferably from 1 to 15.

The antistatic agent or the blend of more that one antistatic agents are preferably comprised in the metallocene polypropylene in an amount of at least 100 ppm, more preferably of at least 250 ppm, even more preferably of at least 500 ppm, even more preferably of at least 750 ppm, still even more preferably of at least 1000 ppm, and most preferably of at least 1250 ppm. The one or more antistatic agents are preferably comprised in the metallocene polypropylene in an amount of at most 20,000 ppm or 15,000 ppm or 10,000 ppm, more preferably of at most 9,000 ppm or 8,000 ppm, even more preferably of at most 7,000 ppm or 6,000 ppm and most preferably of at most 5,000 ppm. The content of antistatic agent is given in weight relative to the total weight of the metallocene polypropylene.

Component (C)

Component (C) is a thermoplastic polymer or a blend of at least two thermoplastic polymers, with the provision that such thermoplastic polymer is different from component (A).

The one or more thermoplastic polymer can be selected from the group consisting of propylene homopolymers, random copolymers of propylene and at least one comonomer with the comonomer as defined above, heterophasic copolymers of propylene and at least one comonomer, ethylene homopolymers, copolymers of ethylene and at least one comonomer with the comonomer as defined above, under the provision that the one or more thermoplastic polymers is different from component (A).

By “different from component (A)” is meant that the thermoplastic polymer differs in at least one property from the metallocene polypropylene as defined above. Said property may for example be the respective composition, such as that the thermoplastic polymer has different comonomer(s), or the comonomer content; be produced with a different polymerization catalyst, such as for example a Ziegler-Natta polymerization catalyst; or a different melt flow index; or have a different tacticity, i.e. a different content of mmmm pentads and be for example a syndiotactic polypropylene. The thermoplastic polymer is preferably not a metallocene polypropylene homopolymer.

The thermoplastic polymer is preferred to have a melt flow index as defined above for the metallocene polypropylene.

The present polypropylene composition are used to produce articles by a transformation process selected from the group consisting of injection molding, extrusion blow molding, extrusion-thermoforming, sheet extrusion, film extrusion, pipe extrusion, and injection stretch-blow molding. Injection molding is, however, preferred. Hence, the present application also discloses a process, wherein a polypropylene composition as defined above is provided and transformed into an articles by a process selected from one of said transformation processes.

The present polypropylene composition may be used for household articles, storage boxes, crates, toys, caps and closures, packaging articles, cups, garden furniture, pipe, films, sheet, corrugated sheet, panels etc.

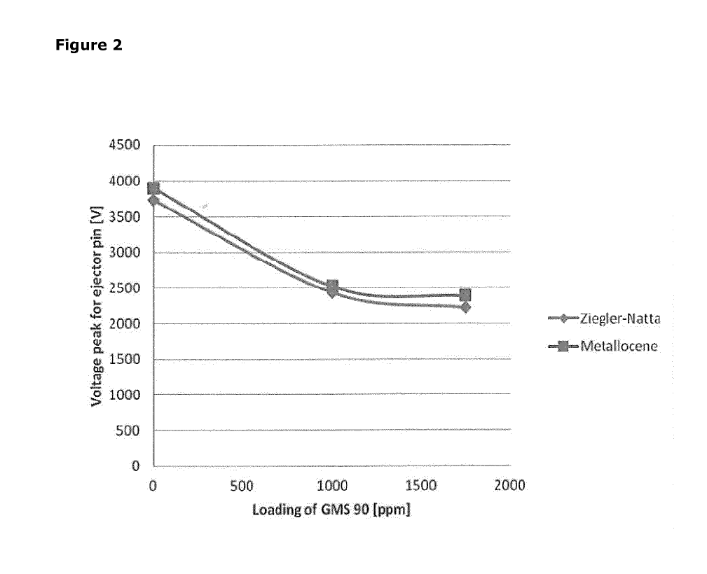

It has now very surprisingly been found that articles produced with the present polypropylene composition are characterized by improved additive retention, particularly as such effect is not observed with polypropylene compositions wherein the metallocene polypropylene is replaced by a polypropylene produced with a Ziegler-Natta polymerization catalyst. The finding is even more surprising as, in the mold, no relevant difference was observed between the migrations of the additive in the present polypropylene composition and in a polypropylene produced with a Ziegler-Natta polymerization catalyst (FIG. 2).

“Improved additive retention” can imply that additives, the migration of which to the surface of the article is not desired, are better retained within the polypropylene, and in consequence do not—or in reduced extent—lead to undesired effects. Alternatively, “improved additive retention” can also imply that additives, the migration of which to the surface of the article is desired, are released over an extended period of time. Such an effect is particularly desirable for example with antistatic agents. On the one hand it is desired that they accumulate on the surface in a concentration such that the desired effect, for example avoidance of dust build-up, is attained. On the other hand, the concentration should not be so high that blooming occurs. “Blooming” denotes the effect that too much antistatic agent arrives at the surface and gives the surface a matte and splotchy (“non-glossy”) look.

Hence, the present application also relates to the use of a polypropylene composition as defined above to reduce the migration rate of component (B) as defined above, characterized in that the difference in gloss of the 1 mm thick injection molded plaques measured three days following injection molding and 25 days following injection is at most 70% of the difference in gloss of the 1 mm thick injection molded plaques stored at 40° C.±1° C. measured three days following injection molding and 25 days following injection molding for the same polypropylene composition wherein for component (A) the polypropylene produced with a polymerization catalyst comprising a metallocene was substituted with a polypropylene produced with a Ziegler-Natta polymerization catalyst.

Test Methods

Melt flow index (MFI) is determined according to ISO 1133, condition L, at 230° C. and 2.16 kg.

Gloss is measured in accordance with ASTM D 2457 at an angle of 20°.

Molecular weights are determined by Size Exclusion Chromatography (SEC) at high temperature (145° C.). A 10 mg polypropylene sample is dissolved at 160° C. in 10 ml of trichlorobenzene (technical grade) for 1 hour. Analytical conditions for the GPCV 2000 from WATERS are:
Injection volume: +/−400 μl
Automatic sample preparation and injector temperature: 160° C.
Column temperature: 145° C.
Detector temperature: 160° C.
Column set : 2 Shodex AT-806MS and 1 Styragel HT6E
Flow rate: 1 ml/min
Detector: Infrared detector (2800-3000 cm⁻¹)
Calibration: Narrow standards of polystyrene (commercially available)
Calculation for polypropylene: Based on Mark-Houwink relation (log₁₀(M_{PP})=log₁₀(M_{PS})−0.25323); cut-off on the low molecular weight end at M_{PP}=1000.

The molecular weight distribution (MWD) is then calculated as M_{w}/Mₙ.

Xylene solubles (XS), i.e. the xylene soluble fraction, are determined as follows: Between 4.5 and 5.5 g of propylene polymer are weighed into a flask and 300 ml xylene are added. The xylene is heated under stirring to reflux for 45 minutes. Stirring is continued for 15 minutes without heating. The flask is then placed in a thermostat bath set to 25° C.+/−1° C. for 1 hour. The solution is filtered through Whatman n° 4 filter paper and 100 ml of solvent are collected. The solvent is then evaporated and the residue dried and weighed. The percentage of xylene solubles (“XS”), i.e. the amount of the xylene soluble fraction, is then calculated according to

XS (in wt %)=(Weight of the residue/Initial total weight of PP)*300

with all weights being in the same unit, such as for example in grams.

The ¹³C-NMR analysis is performed using a 400 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice the intensity of a signal is obtained from its integral, i.e. the corresponding area. The data is acquired using proton decoupling, 4000 scans per spectrum, a pulse repetition delay of 20 seconds and a spectral width of 26000 Hz. The sample is prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as internal standard. To give an example, about 200 mg of polymer are dissolved in 2.0 ml of TCB, followed by addition of 0.5 ml of C₆D₆ and 2 to 3 drops of HMDS.

Following data acquisition the chemical shifts are referenced to the signal of the internal standard HMDS, which is assigned a value of 2.03 ppm.

The isotacticity is determined by ¹³C-NMR analysis on the total polymer. In the spectral region of the methyl groups the signals corresponding to the pentads mmmm, mmmr, mmrr and mrrm are assigned using published data, for example A. Razavi, Macromol. Symp., vol. 89, pages 345-367. Only the pentads mmmm, mmmr, mmrr and mrrm are taken into consideration due to the weak intensity of the signals corresponding to the remaining pentads. For the signal relating to the mmrr pentad a correction is performed for its overlap with a methyl signal related to 2,1-insertions. The percentage of mmmm pentads is then calculated according to

% mmmm=AREAₘₘₘₘ/(AREAₘₘₘₘ+AREAₘₘₘᵣ+AREAₘₘᵣᵣ+AREAₘᵣᵣₘ)·100

Determination of the percentage of 2,1-insertions for a metallocene propylene homopolymer: The signals corresponding to the 2,1-insertions are identified with the aid of published data, for example H. N. Cheng, J. Ewen, Makromol. Chem., vol. 190 (1989), pages 1931-1940. A first area, AREA1, is defined as the average area of the signals corresponding to 2,1-insertions. A second area, AREA2, is defined as the average area of the signals corresponding to 1,2-insertions. The assignment of the signals relating to the 1,2-insertions is well known to the skilled person and need not be explained further. The percentage of 2,1-insertions is calculated according to

2,1-insertions (in %)=AREA1/(AREA1+AREA2)·100

with the percentage in 2,1-insertions being given as the molar percentage of 2,1-inserted propylene with respect to total propylene.

The determination of the percentage of 2,1-insertions for a metallocene random copolymer of propylene and ethylene is determined by two contributions:
(i) the percentage of 2,1-insertions as defined above for the propylene homopolymer, and
(ii) the percentage of 2,1-insertions, wherein the 2,1-inserted propylene neighbors an ethylene,
   thus the total percentage of 2,1-insertions corresponds to the sum of these two contributions. The assignments of the signal for case (ii) can be done either by using reference spectra or by referring to the published literature.

### EXAMPLE

The advantages of the present invention are illustrated using the polypropylene compositions as indicated in Table 1.

TABLE 1

| | Component (A) | Component (A) | Component (B) |
|---|---|---|---|
| | [wt %] | [wt %] | [wt %] |
| | Type | | |
| | PP1 | PP2 | GMS90 |
| Example 1 | 99.900 | | 0.100 |
| Example 2 | 99.825 | | 0.175 |
| Comparative example 1 | | 99.900 | 0.100 |
| Comparative example 2 | | 99.825 | 0.175 |

PP1 is a polypropylene produced with a metallocene-based polymerization catalysts, wherein the metallocene is a supported bridged (bis-disubstituted-indenyl) zirconocene. PP1 is a C3-C2 copolymer having a melt flow index of 110 dg/min and an ethylene content of 2 wt %.
PP2 is a polypropylene produced with a Ziegler-Natta polymerization catalyst. PP2 is a C3-C2 copolymer having a melt flow index of 80 dg/min, and an ethylene content of 3.5 wt %.
GMS90 is a commercially available antistatic agent with a content of glycol monostearate of 90 wt %.

Blooming, or migration of the antistatic agent to the surface of an article consisting of the polypropylene compositions of Examples 1 and 2 as well as Comparative Examples 1 and 2 was checked using gloss at 20° as an indicator. Gloss was determined on 1 mm thick plaques, which were injection molded on a 60 ton Netstal injection molding machine with a barrel temperature of 230° C.

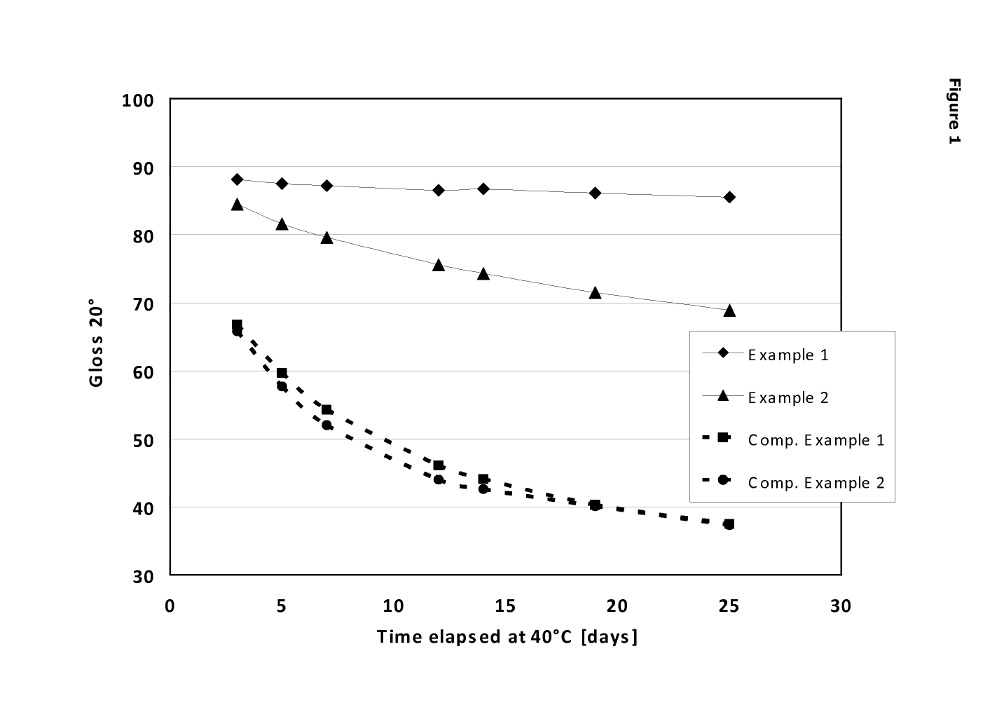

The results of the gloss measurements are shown in FIG. 1.

FIG. 2 shows the migration, in the mold of the antistatic agent GMS90 in a Ziegler Natta polypropylene and in a metallocene polypropylene. In the mold, no relevant difference was observed between the migration of the GMS90. However, in the longer term, significant differences were observed as GMS 90 is migrating much faster in the Ziegler Natta polypropylene than in the metallocene polypropylene (FIG. 1).

1-8. (canceled)

9. A polypropylene composition comprising:
(i) x wt % of component (A), wherein the component (A) is a random copolymer of propylene and ethylene produced with a metallocene-based polymerization catalyst and has a molecular weight distribution, defined as M_{w}/Mₙ, of at most 4.0, and wherein x is at least 70;
(ii) y wt % of component (B), wherein the component (B) is an additive that migrates to a surface of the polypropylene composition, and wherein y is at least 0.001 and at most 2.0; and
(iii) (100−x−y) wt % of component (C), wherein the component (C) is a thermoplastic polymer different from the component (A), and wherein the thermoplastic polymer is not a metallocene polypropylene homopolymer;
with the provision that x+y≦100, wherein wt % is defined relative to a total weight of the polypropylene composition;
wherein the polypropylene composition has a gloss at 20° of at least 75, determined on 1 mm thick plaques having been produced by injection molding and stored at 40° C.±1° C. for three days before measuring gloss at 20° in accordance with ASTM D 2457.

10. The polypropylene composition according to claim 9, wherein the component (A) has a content of mmmm pentads of at least 90%.

11. The polypropylene composition according to claim 9, wherein the component (A) has a content of 2,1-insertions of at least 0.1% and of at most 1.5%.

12. The polypropylene composition according to claim 9, wherein the component (B) is an antistatic agent.

13. An article consisting of the polypropylene composition of claim 9.

14. An article comprising the polypropylene composition of claim 9.

15. A process for producing an article having improved additive retention, the process comprising:
(a) providing the polypropylene composition of claim 9; and
(b) transforming the polypropylene composition into an article by injection molding, extrusion blow molding, extrusion-thermoforming, sheet extrusion, film extrusion, pipe extrusion, or injection stretch-blow molding.

16. An article formed by the process of claim 15.

17. The polypropylene composition according to claim 9, characterized in that a difference in gloss of the 1 mm thick injection molded plaques measured three days following injection molding and 25 days following injection of the polypropylene composition is at most 70% of a difference in gloss of 1 mm thick injection molded plaques stored at 40° C.±1° C. measured three days following injection molding and 25 days following injection molding of a second polypropylene composition;
wherein the second polypropylene composition is the same as the polypropylene composition, with the exception that the component (A) is substituted with a polypropylene produced with a Ziegler-Natta polymerization catalyst; and
wherein the polypropylene composition exhibits a reduced migration rate of the component (B) in comparison to the migration rate of the component (B) in the second polypropylene composition.
